(19) United States
(12) Patent Application Publication
(10) Pub. No.: US 2018/0194030 A1
(43) Pub. Date: Jul. 12, 2018

(54) CUT DATA GENERATING APPARATUS AND NON-TRANSITORY RECORDING MEDIUM STORING CUT DATA GENERATING PROGRAM

(71) Applicant: BROTHER KOGYO KABUSHIKI KAISHA, Nagoya-shi (JP)

(72) Inventors: Aki YOKOYAMA, Nagoya-shi (JP); Tsuneo OKUYAMA, Nagoya-shi (JP)

(21) Appl. No.: 15/914,720

(22) Filed: Mar. 7, 2018

Related U.S. Application Data
(63) Continuation of application No. PCT/JP2016/069413, filed on Jun. 30, 2016.

(30) Foreign Application Priority Data
Sep. 30, 2015 (JP) 2015-193616

(51) Int. Cl. B26D 5/00

(52) U.S. Cl. CPC B26D 5/005; B26D 2005/002; B26D 5/007

(57) ABSTRACT

A cut data generating apparatus for generating cut data for allowing a cutting apparatus including a cutting mechanism to cut a pattern out of a cut target workpiece, includes a controller, the controller being configured to control the cut data generating apparatus to: specify an original pattern that is a target of cutting; generate a reinforcement pattern that is accommodated in an inside of a shape of at least a part of the original pattern based on a shape of the specified original pattern, and is overlaid on the original pattern to achieve reinforcement; and generate cut data for cutting the original pattern and a reinforcement pattern out of the cut target workpiece.

### CROSS-REFERENCE TO RELATED APPLICATION

This application is a continuation application of International Application No. PCT/JP2016/069413, filed on Jun. 30, 2016, which claims priority from Japanese Patent Application No. 2015-193616, filed on Sep. 30, 2015. The disclosure of the foregoing application is hereby incorporated by reference in its entirety.

### FIELD

The present disclosure relates a cut data generating apparatus, and a non-transitory recording medium storing a cut data generating program that generate cut data for allowing a cutting apparatus including a cutting mechanism to cut a pattern having a predetermined shape out of a cut target workpiece.

### BACKGROUND

Conventionally, a cutting apparatus has been known that allows a cutting mechanism to cut a predetermined shape out of a sheet-shaped cut target workpiece, such as paper, based on cut data. Such an apparatus is configured to perform a cutting operation by moving the cut target workpiece in the forward and rearward (Y) direction while moving a cutter in the left and right (X) direction, based on cut data in conformity with a pattern shape in a state where the cut target workpiece is held by a dedicated mat.

Accordingly, for example, a letter pattern F of “A” exemplified in FIG. 6A is cut out of paper and used for decoration.

### SUMMARY

Unfortunately, in a case of thin paper, a narrow portion and a portion bent at a right angle in the letter pattern F, for example, a lateral bar in the letter pattern F of “A”, that is, line L portions and the like illustrated in FIG. 6B are prone to being torn. Accordingly, in a case where the cut object is used for the decoration as a single piece of work, the object is sometimes actually torn.

The present disclosure is made in view of the situations described above, and has an object to provide a cut data generating apparatus and a non-transitory recording medium storing a cut data generating program that are capable of generating cut data for cutting a pattern having a predetermined shape out of a cut target workpiece, the cut data being for allowing a cutting apparatus to cut a reinforcement part for reinforcing a portion prone to being torn to prevent the cut object from being torn.

To achieve the object described above, a cut data generating apparatus according to the present disclosure that generates cut data for allowing a cutting apparatus including a cutting mechanism to cut a pattern out of a cut target workpiece, includes a controller, the controller being configured to control the cut data generating apparatus to: specify an original pattern that is a target of cutting; generate a reinforcement pattern that is accommodated in an inside of a shape of at least a part of the original pattern based on a shape of the specified original pattern, and is overlaid on the original pattern to achieve reinforcement; and generate cut data for cutting the original pattern and the reinforcement pattern out of the cut target workpiece.

This summary is not intended to identify critical or essential features of the disclosure, but instead merely summarizes certain features and variations thereof. Other details and features will be described in the sections that follow.

### BRIEF DESCRIPTION OF THE DRAWINGS

Aspects of the disclosure are illustrated by way of example, and not by limitation, in the accompanying figures in which like reference characters may indicate similar elements.

FIG. 1 is a perspective view illustrating a first embodiment of the present disclosure and schematically illustrating an appearance of a cutting apparatus serving as a cut data generating apparatus;

FIG. 2 is a block diagram schematically illustrating an electrical configuration of the cutting apparatus;

FIG. 3 is a flowchart illustrating processing procedures of generating cut data executed by a controller (Stage 1);

FIG. 4 is a flowchart illustrating processing procedures of generating cut data executed by the controller (Stage 2);

FIG. 5 is a flowchart illustrating processing procedures of generating cut data executed by the controller (Stage 3);

FIG. 6A is a diagram illustrating an original pattern of “A”;

FIG. 6B is a diagram illustrating the position of a line prone to being torn with respect to the original pattern “A”;

FIG. 6C is a diagram illustrating a situation of setting a reinforcement range;

FIG. 6D is a diagram illustrating a situation of range integration;

FIG. 7A is a diagram illustrating an example of arrangement of a reinforcement pattern for the original pattern “A” (Stage 1);

FIG. 7B is a diagram illustrating the example of arrangement of the reinforcement pattern for the original pattern “A” (Stage 2);

FIG. 7C is a diagram illustrating the example of arrangement of the reinforcement pattern for the original pattern “A” (Stage 3);

FIG. 7D is a diagram illustrating the example of arrangement of the reinforcement pattern for the original pattern “A” (Stage 4);

FIG. 8A is a diagram for illustrating a method of setting an inverted reinforcement pattern (Example 1);

FIG. 8B is a diagram for illustrating a method of setting an inverted reinforcement pattern (Example 2);

FIG. 8C is a diagram for illustrating a method of setting an inverted reinforcement pattern (Example 3);

FIG. 8D is a diagram for illustrating a method of setting an inverted reinforcement pattern (Example 4);

FIG. 8E is a diagram for illustrating a method of setting an inverted reinforcement pattern (Example 5);

FIG. 9A is a diagram illustrating an original pattern of “B”;

FIG. 9B is a diagram illustrating the position of a line prone to being torn with respect to the original pattern “B”;

FIG. 9C is a diagram illustrating a situation of setting a reinforcement range;

FIG. 9D is a diagram illustrating a situation of arrangement of the reinforcement pattern;

FIG. 10A is a diagram illustrating an original pattern of “B”;

FIG. 10B is a diagram illustrating the position of a line prone to being torn with respect to the original pattern “B”;

FIG. 10C is a diagram illustrating a situation of setting a reinforcement range that is different from that in FIG. 9C;

FIG. 10D is a diagram illustrating a situation of arrangement of the reinforcement pattern;

FIG. 11A is a diagram illustrating an original pattern of “O”;

FIG. 11B is a diagram illustrating the position of a line prone to being torn with respect to the original pattern “O”;

FIG. 11C is a diagram illustrating a situation of setting reinforcement ranges;

FIG. 11D is a diagram illustrating a situation of arrangement of the reinforcement pattern;

FIG. 12 is a diagram illustrating a second embodiment and illustrating appearances of a cut data generating apparatus and a cutting apparatus; and

FIG. 13 is a block diagram schematically illustrating electrical configurations of the cut data generating apparatus and the cutting apparatus.

### DETAILED DESCRIPTION

For a more complete understanding of the present disclosure, needs satisfied thereby, and the objects, features, and advantages thereof, reference now is made to the following descriptions taken in connection with the accompanying drawings. Hereinafter, illustrative embodiments will be described with reference to the accompanying drawings.

### (1) First Embodiment

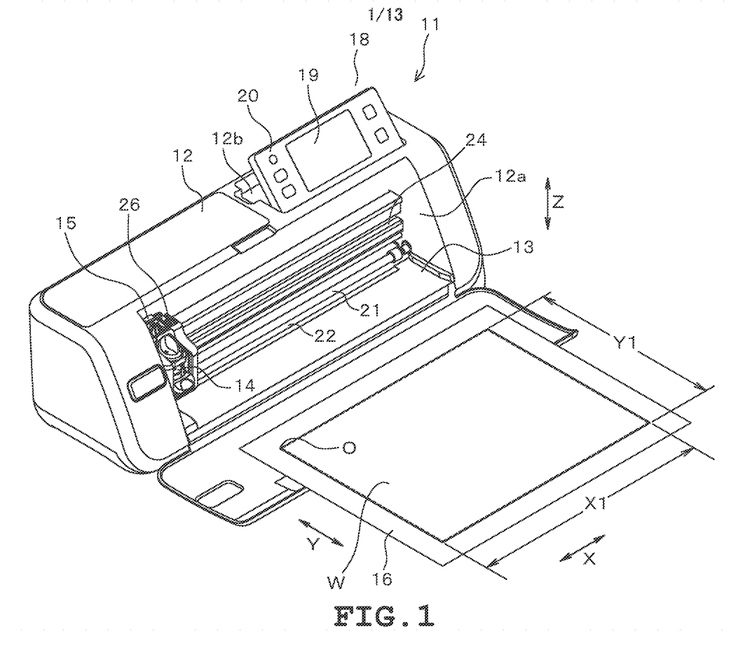

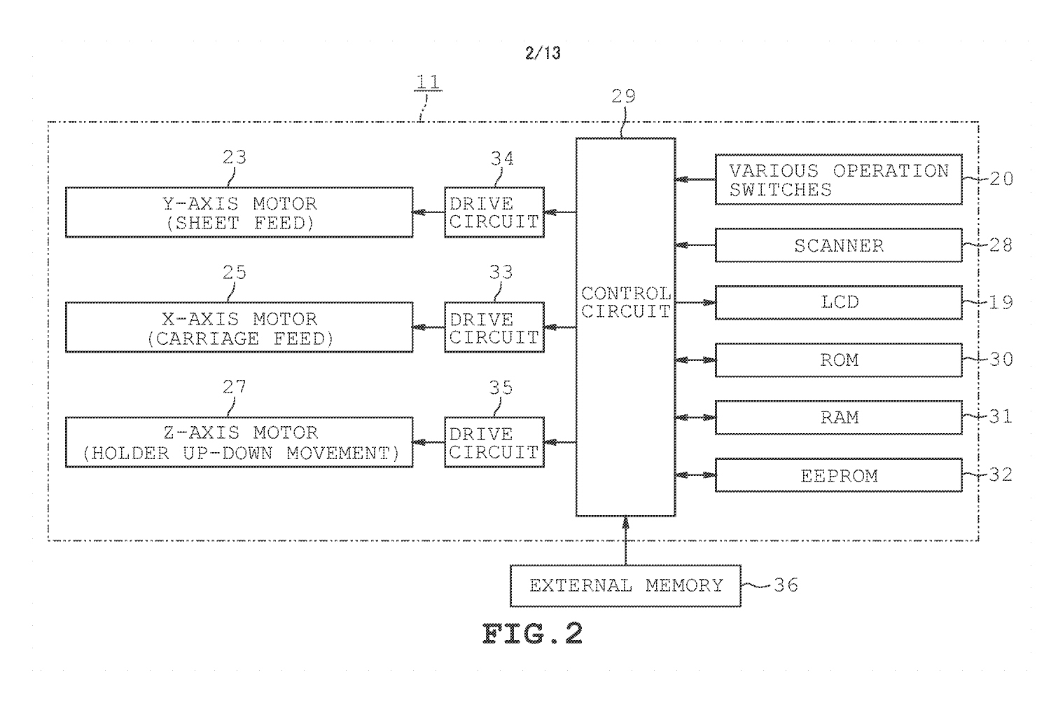

Hereinafter, a first embodiment that is a specific implementation of the present disclosure is described with reference to FIGS. 1 to 11. In the first embodiment, a cutting apparatus also serves as a cut data generating apparatus. FIG. 1 illustrates an appearance configuration of the cutting apparatus 11 serving as the cut data generating apparatus according to this embodiment. FIG. 2 schematically illustrates the electrical configuration of the cutting apparatus 11. The cutting apparatus 11 is an apparatus that cuts a cut target workpiece W, such as paper or a sheet, according to cut data.

As illustrated in FIG. 1, the cutting apparatus 11 includes a body cover 12, a platen 13 disposed in the body cover 12, and a cut head 15 that includes a cutter cartridge 14. The cutting apparatus 11 includes a holding member 16 for holding the cut target workpiece W serving as a cutting target workpiece. The holding member 16 includes a base portion that has an overall shape of a rectangular thin plate, and an adhesive layer provided on an upper surface of the base portion. The adhesive layer is provided to have a rectangular shape except the edge portions of four sides of the base portion, and holds the cut target workpiece W in a peelable manner

Here, the directions in this embodiment are defined. The feed direction of the holding member 16 by a feed mechanism described later is defined as the forward and rearward direction (Y direction). The transfer direction of the cut head 15 by a cutter transfer mechanism described later is defined as the left and right direction (X direction). The direction orthogonal to the forward and rearward direction and the left and right direction is defined as the up and down direction (Z direction). As illustrated in FIG. 1, the cutting apparatus 11 employs an X-Y coordinate system with the left rear corner of the adhesive portion of the holding member 16 being an origin O, and controls the cutting operation based on cut data indicated by the X-Y coordinate system. The adhesive layer of the holding member 16 has the sides extending in the X and Y directions. The size of the cut target workpiece W that can be held has dimensions of X1 in the left and right direction and dimensions of Y1 in the forward and rearward direction.

The body cover 12 has a laterally elongated rectangular box shape. A front surface opening 12a that opens in a laterally elongated manner is formed at the front surface portion of this cover. The holding member 16 is inserted from the front surface opening 12a into the cutting apparatus 11, and is set on the upper surface of the platen 13. The holding member 16 set on the platen 13 is fed in the Y direction.

An operation panel 18 is provided at a right portion on the upper surface of the body cover 12. The operation panel 18 includes a liquid crystal display (LCD) 19, and various operation switches 20 for allowing a user to perform various operations of designation, selection or input. The various operation switches 20 include a touch panel provided on the surface of the LCD 19. A feed mechanism that feeds the holding member 16 on the upper surface of the platen 13 in the Y direction is provided in the body cover 12. Furthermore, a cutter transfer mechanism that transfers the cut head 15 in the X direction is provided.

The feed mechanism is described. A pinch roller 21 and a drive roller 22 that each extend in the left and right direction are provided to be arranged on an upper position and a lower position, respectively, in the body cover 12. The holding member 16 is fed in the forward and rearward direction with left and right edge portions being clamped between the pinch roller 21 and the drive roller 22. Although not illustrated in detail, a Y-axis motor 23 (illustrated only in FIG. 2), and a gear mechanism that transmits the rotation of the Y-axis motor 23 to the drive roller 22 are provided at a right side portion in the body cover 12. Accordingly, the drive roller 22 is rotated by the Y-axis motor 23, thereby allowing the feed mechanism to feed the holding member 16 in the forward and rearward direction.

Next, the cutter transfer mechanism is described. A guide rail 24 that is disposed rear and above the pinch roller 21 and extends in the left and right direction is arranged in the body cover 12. The cut head 15 is supported by the guide rail 24 in a manner movable in the left and right direction. Although not illustrated in detail, an X-axis motor 25 (illustrated only in FIG. 2), and a drive pulley rotated by the X-axis motor 25 are provided at a left side portion in the body cover 12.

On the other hand, although not illustrated, a follower pulley is provided at a right side portion in the body cover 12. An endless timing belt extends in the left and right direction between the drive pulley and the follower pulley, and is horizontally wound around these pulleys. An intermediate portion of the timing belt is coupled to the cut head 15. Accordingly, the cutter transfer mechanism transfers the cut head 15 in the left and right direction through the timing belt by the rotation of the X-axis motor 25.

The cut head 15 includes a cartridge holder 26, and an up-down drive mechanism that drives the cartridge holder 26. The cartridge holder 26 detachably holds the cutter cartridge 14. Although not illustrated, the cutter cartridge 14 includes a cutter. At a lower end of the cutter, a blade is formed. The cutter cartridge 14 holds the cutter at a position allowing the blade to protrude slightly from the lower end portion of the case.

The up-down drive mechanism includes a Z-axis motor 27 (illustrated only in FIG. 2), and is configured to transfer the cutter cartridge 14 between a lowered position at which the cut target workpiece is cut by the blade of the cutter and a lifted position at which the blade of the cutter is separated from the cut target workpiece by a predetermined distance. At the normal time, that is, a time at which no cutting operation is performed, the cutter cartridge 14 is positioned at the lifted position. At the time of cutting operation, this cartridge is moved to the lowered position by the up-down drive mechanism.

The cutting mechanism is configured as described above. At the time of cutting operation, the blade of the cutter is in a state of penetrating the cut target workpiece W, which is the cut target workpiece held by the holding member 16, in the thickness-wise direction. In this state, the feed mechanism moves the cut target workpiece W held by the holding member 16 in the forward and rearward direction, and the cutter transfer mechanism moves the cut head 15, i.e., the cutter, in the left and right direction, thereby applying the cutting operation to the cut target workpiece W. As illustrated only in FIG. 2, the cutting apparatus 11 in this embodiment includes a scanner 28 that reads a pattern on the surface of an original diagram or the like held by the holding member 16.

As illustrated in FIG. 2, the cutting apparatus 11 includes a control circuit 29 as a control unit. The control circuit 29 is made up mainly of a computer (CPU), and is responsible for the overall control of the cutting apparatus 11. The LCD 19 and the various operation switches 20, and a ROM 30, a RAM 31 and an EEPROM 32 are connected to the control circuit 29. Drive circuits 33, 34 and 35 that drive the X-axis motor 25, the Y-axis motor 23 and the Z-axis motor 27, respectively, are connected to the control circuit 29. Furthermore, an external memory 36, for example an USB memory or the like, is connectable to the control circuit 29.

The ROM 30 stores various control programs, such as a cut control program for controlling the cutting operation, a cut data generating program that generates and edits the cut data, and a display control program that controls the display of the LCD 19. The RAM 31 temporarily stores data and programs required for various processes. The EEPROM 32 or the external memory 36 stores pattern data representing shapes pertaining to various patterns, and cut data generated to cut the patterns having predetermined shapes.

The EEPROM 32 stores data on the size of the cut target workpiece W which can be held by the holding member 16, that is, data on the left-and-right dimensions of X1 and front-and-rear dimensions of Y1 in this case. The size of the cut target workpiece W may be preliminarily stored. Alternatively, the size of the actual cut target workpiece W held by the holding member 16 may be identified, and the size of the cut target workpiece W may be stored in the EEPROM 32. In this case, a method for identifying the size of the actual cut target workpiece W may be, for example, manual input by a user, measurement of the size of the cut target workpiece W on the holding member 16 by the scanner 28 or the like.

The cut data indicates a cut position for cutting the cut target workpiece W, and is made up of a set of data items having coordinate values that indicate cut positions in the X-Y coordinate system. The control circuit 29 executes the cut control program to thereby control the X-axis motor 25, the Y-axis motor 23 and the Z-axis motor 27 through the respective drive circuits 33, 34 and 35 according to the cut data, and to automatically execute the cutting operation for the cut target workpiece W held by the holding member 16.

In this embodiment, the control circuit 29 executes the cut data generating program to execute each process as the cut data generating apparatus that generates the cut data. The cut data generating program is not limited to a program preliminarily stored in the ROM 30. Alternatively, the cut data generating program may be configured to be recorded in an external non-transitory recording medium, for example, an optical disk or the like and to be read from the non-transitory recording medium. Furthermore, the program may be a program to be downloaded from the outside via a network.

For example, the cut data is generated by acquiring outlines that represent a pattern made up of a closed diagram from among multiple patterns stored in the EEPROM 32 or read from the scanner 28 based on pattern data on a pattern selected and specified, as a target of cutting, by the user through operations of the various operation switches 20, and by generating the cut data for cutting along the outline based on the outline data.

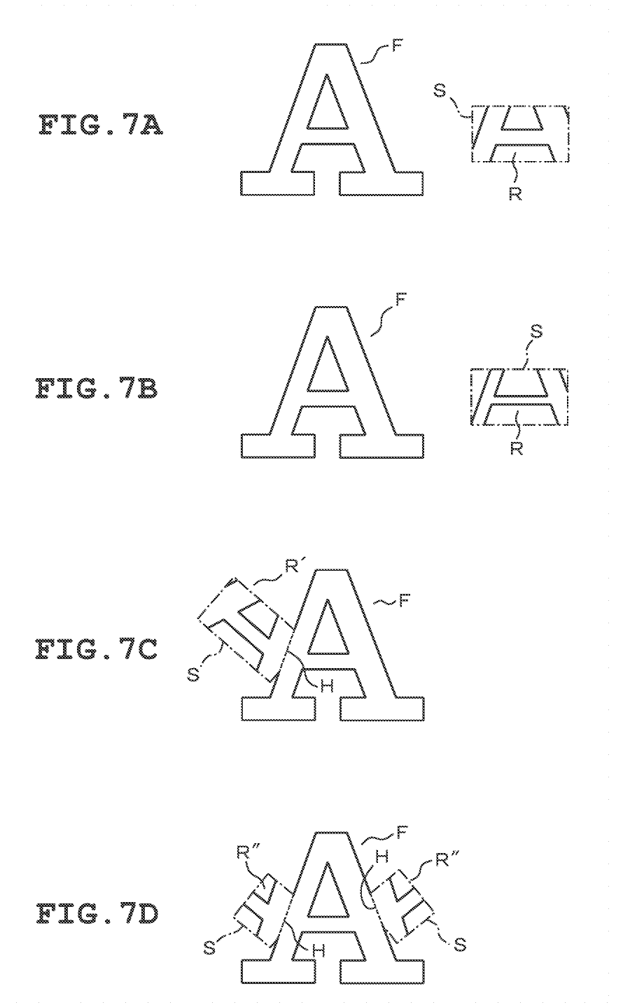

Here, according to this embodiment, for generating the cut data, the control circuit 29 generates a reinforcement pattern R (see FIGS. 7A to 7D, etc.) that is accommodated in at least the partial shape of a pattern (called an original pattern F) that is the target specified by the user and is for reinforcement by being overlaid on the original pattern F, based on the shape of the original pattern F, from the pattern data on the original pattern F. In this case, the reinforcement pattern R is for reinforcing a part prone to being torn in an object acquired by cutting the original pattern F out of the cut target workpiece W, such as paper. A reinforcement part is fabricated by cutting the reinforcement pattern R out of the cut target workpiece W. The reinforcement part is pasted on, for example, the rear surface of the cut original pattern F, thereby achieving reinforcement.

In a case where the reinforcement pattern R is generated, the control circuit 29 generates cut data for cutting both the original pattern F and the reinforcement pattern R out of the cut target workpiece W. Consequently, the various operation switches 20 function as a specification unit, and the control circuit 29 functions as a reinforcement pattern generating unit and a cut data generating unit. In a case where the reinforcement pattern R is not generated, cut data for cutting the original pattern F out of the cut target workpiece W is generated based on the pattern data on the original pattern F.

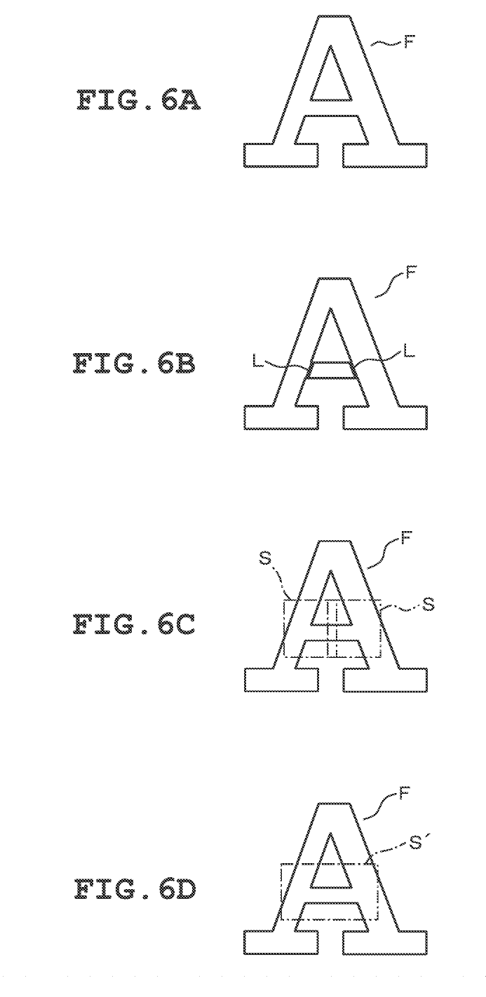

A described in detail later, according to this embodiment, for generating the reinforcement pattern R for the original pattern F, the control circuit 29 detects a narrow width portion or a bent portion in the original pattern F as a fragile spot, and sets a predetermined range (called a reinforcement range S) for reinforcement on a part of the original pattern F so as to contain the fragile spot. In this case, as illustrated in FIGS. 6A to 6D, etc., the reinforcement range S is set as, for example, a rectangular range centered at the fragile portion. The control circuit 29 generates the reinforcement pattern R corresponding to the shape of a partial pattern that is of the original pattern F and is contained in the reinforcement range S. Consequently, the control circuit 29 also functions as a range setting unit. Note that corner portions of the outline of the original pattern F that have bent shapes may be detected as the fragile spots.

Here, FIGS. 6A to 6D illustrate the original pattern F made up of a letter pattern of “A” as an example of a pattern. As illustrated in 6A, in the original pattern F of “A”, a laterally extending narrow width portion is a fragile spot. Portions specifically prone to being torn are line L portions of the narrow width portion at the opposite ends as illustrated in FIG. 6B. Here, a spot in the original pattern F that has a width dimension less than a threshold, for example, 5 mm is detected as the fragile spot. The threshold may be set by default and stored in EEPROM 32. Alternatively, the threshold may be freely change and set by the user.

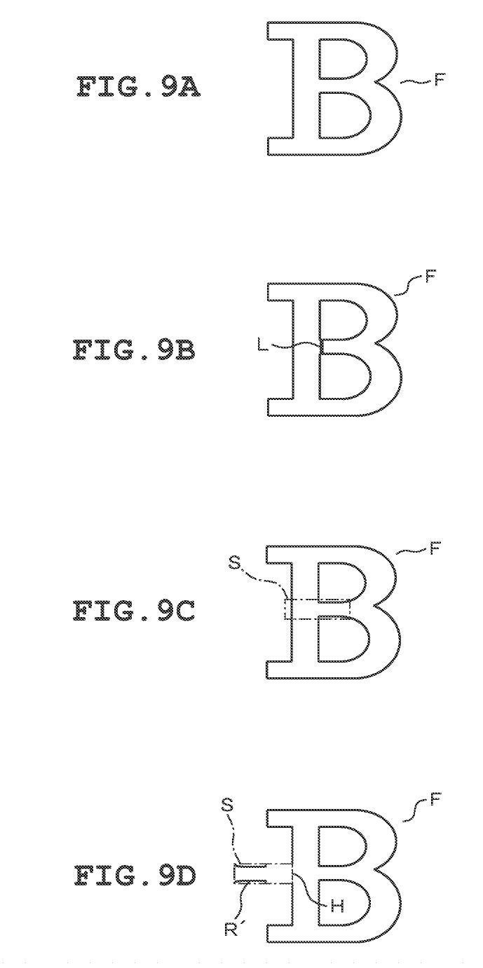

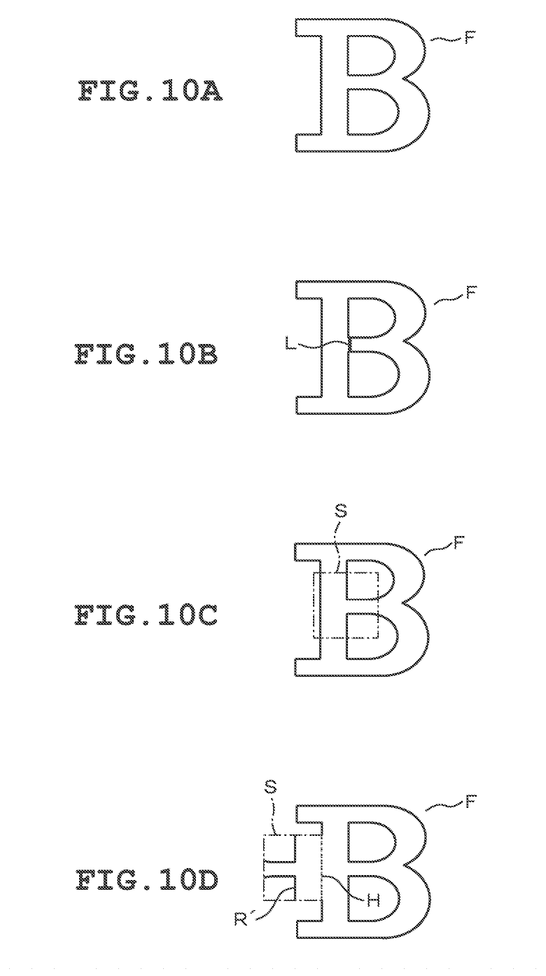

For setting the reinforcement range S, the control circuit 29 sets the size of the reinforcement range S according to the width dimension of the fragile spot. A default table is stored in the EEPROM 32. For example, in the case where the width dimension threshold for determining the fragile spot of the original pattern F is 5 mm, the size of the reinforcement range S may be a size of 20 mm×20 mm, for example. For example, in a case where the threshold is 8 mm, the size of the reinforcement range S is a size of 30 mm×30 mm Note that the user is allowed to change freely the size of the reinforcement range S. In this case, the user is allowed to select whether the reinforcement range S is regarded as a rectangular shape (see FIGS. 10A to 10D) or an elongated shape (see FIGS. 9A to 9D).

According to this embodiment, in a case where multiple fragile spots are detected and multiple reinforcement ranges S are set and where the adjoining reinforcement ranges S are in contact or overlap with each other, the control circuit 29 integrates the reinforcement ranges S to generate the reinforcement pattern R (see FIGS. 6C and 6D). The control circuit 29 can generate the reinforcement pattern R to have a shape equivalent to the shape of a part of the original pattern F in the reinforcement range S, that is, by a scaling rate of 100% (see FIG. 7A). Alternatively, the reinforcement pattern R can be generated to have a form with a reduced width direction dimension with respect to the shape of the part of the original pattern F in the reinforcement range S, for example, by a scaling rate of several tens of percent can be adopted (see FIG. 7B). In this case, the scaling rate by default is, for example, 90%. The user can freely change the numeric value thereof. The width direction in this embodiment is a direction perpendicular to each of the line segments constituting the outline of the original pattern F.

Furthermore, according to this embodiment, the control circuit 29 also functions as an arrangement unit that arranges the reinforcement pattern R and the original pattern F so as to cut the patterns F and R out of one cut target workpiece W. In this case, according to this embodiment, as for fabrication of the reinforcement part, the user is allowed to preset whether a separate part version (see FIGS. 7A and 7B, etc.) is selected or a folded version (see FIGS. 7C and 7D, etc.) is selected. In the case of the separate part version, the reinforcement pattern R is arranged so as to be separated from the original pattern F without contact therewith. On the other hand, in the case of the folded version, the reinforcement pattern R is inverted, an inverted reinforcement pattern R′ and the original pattern F are arranged in a state where the outline of the inverted reinforcement pattern R′ and the outline of the original pattern F are in contact or overlap with each other. Thus, cutting is made in the state where the reinforcement part is integrally joined to the cut object corresponding to the original pattern F, and reinforcement is achieved by folding and pasting the reinforcement part.

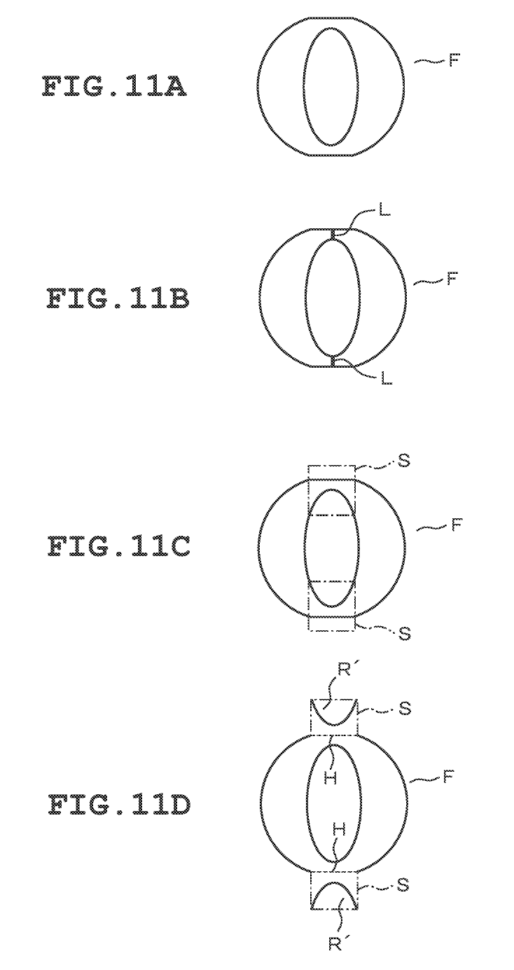

Alternatively, in the case of the folded version and a case where the reinforcement pattern R is generated based on the shape of the multiple line segments constituting the outline of the original pattern F, as illustrated in FIGS. 7D and 11D, the reinforcement pattern R can be divided into multiple patterns according to the multiple line segments, the divided reinforcement patterns R can be inverted, and the multiple divided inverted reinforcement patterns R″ and the original pattern F can be arranged in a form where the outlines of the divided inverted reinforcement patterns R″ and the outline of the original pattern F are in contact or overlap with each other. In this case, the control circuit 29 also functions as a size information acquisition unit that acquires size data that is on the size of the cut target workpiece W. The control circuit 29 then judges whether or not the original pattern F and the inverted reinforcement pattern R′ or the divided inverted reinforcement patterns R″ can be arranged in the size of the cut target workpiece W. If the arrangement is impossible, the reinforcement pattern R is arranged differently from the original pattern F, that is, arranged as a separate part version.

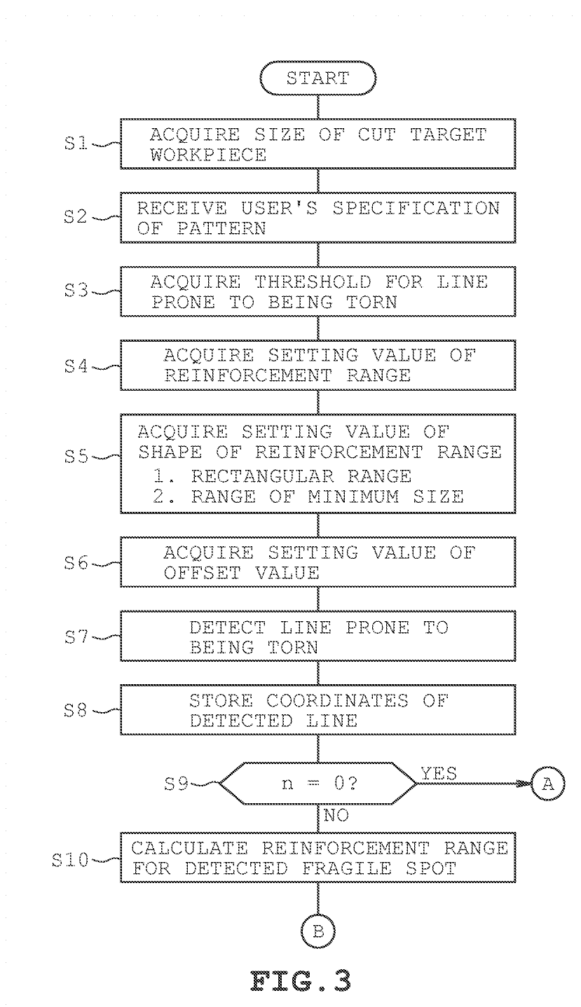

Next, the operation of the configuration described above is described with reference also to FIGS. 3 to 11D. The flowcharts of FIGS. 3 to 5 illustrate processing procedures of generating cut data executed by the control circuit 29 in a case where a cut data generating process is specified by the user's operation through the operation switches 20.

In FIG. 3, first, at step S1, data on the size of the cut target workpiece W where the horizontal and vertical dimensions are X1 and Y1, respectively, in this case (see FIG. 1), is acquired from the EEPROM 32. At step S2, specification of the original pattern F is received based on the user's operation through the operation switches 20. The specified original pattern F is displayed on the LCD 19. At step S3, the fragile spot is detected, that is, the width dimension threshold for judgment is read. In this case, according to the default value of the threshold, a spot having a width dimension less than 5 mm, for example, is regarded as the fragile spot. However, the user is allowed to change the threshold. At step S4, a setting value of the range (reinforcement range S) where the reinforcement pattern is generated is acquired. In this case, if the size is according to the threshold for judgment of the fragile spot, for example, the threshold is 5 mm, a size of 20 mm×20 mm is set as a default value table.

At step S5, the setting value of the shape of the reinforcement range S is acquired. Here, the rectangular range (see FIGS. 6A to 6D, 7A and 7D, 8A to 8E, 10A to 10D and 11A to 11D) or the minimum range (see FIGS. 9A to 9D) are preset by the user. At step S6, an offset value, that is, the setting value of the scaling rate in the width direction of the reinforcement pattern R is acquired. In this case, the default value is 90%, for example. The user can freely set the value to 100% and 80%, for example At step S7, the line L prone to being torn as the fragile spot in the original pattern F is detected. More specifically, bent spots that are spots having a narrower width than the width dimension (e.g., 5 mm) of the threshold read in S3 and are bent spots at which the outline constituting one spot and the outline constituting another spot are connected to each other in a bent or curved manner, are detected. The narrow width portions are opposite two sides. Accordingly, the two bent spots are detected. A line connecting the two spots may be detected as the line L. If the three or more bent spots are detected, a line connecting two bent spots having the minimum distance may be detected as the line L. At step S8, the position coordinates of the line L at the detected n spots are stored. If no line L is detected at step S7, this fact is stored.

At next step S9, it is judged whether the number of lines L as the fragile spots is zero or not. When the number n is zero, that is, no fragile spot resides (Yes in step S9), the reinforcement pattern R is not generated and the process flow proceeds to step S28 described later. If the number n is not zero, that is, one or more fragile spots reside (No in step S9), the setting value of the shape of the reinforcement range S acquired at step S4 and the setting value of the shape of the reinforcement range S acquired at step S5 are used to calculate the reinforcement range S for all the detected fragile spots at next step S10. Here, as illustrated in FIG. 6A, for example, in the case of the original pattern F made up of the letter “A”, the line L with the two fragile spots as illustrated in FIG. 6B is detected. In this example, as indicated with dot chain lines in FIG. 6C, two rectangular reinforcement ranges S are set.

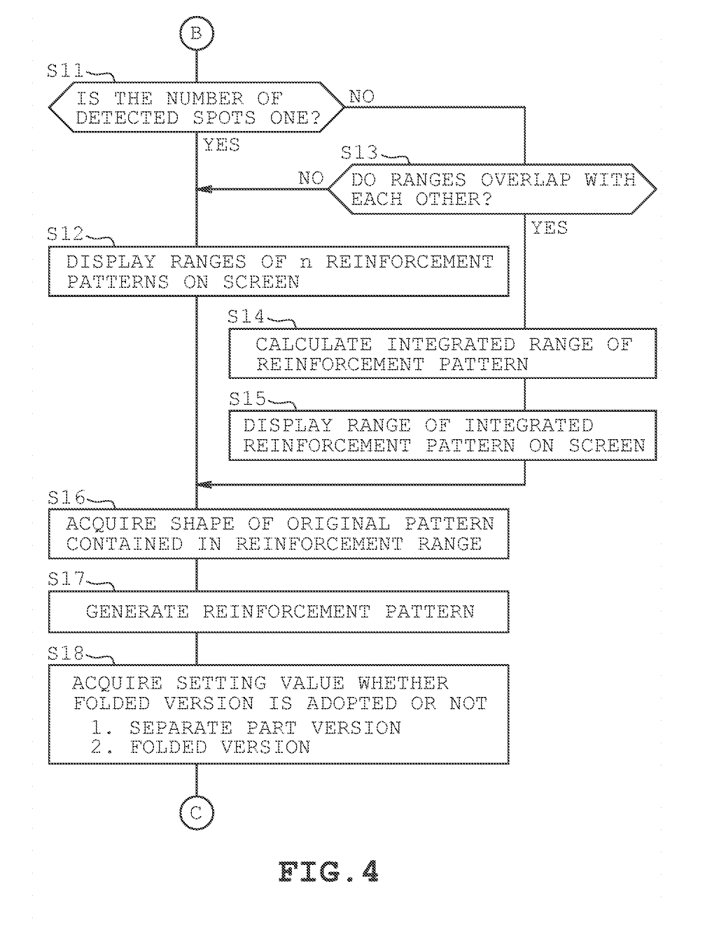

The process flow proceeds to FIG. 4. At next step S11, it is judged whether or not the number of detected fragile spots is one. If the number is one (Yes in step S11), the process flow proceeds to step 512, at which the reinforcement range S corresponding to the fragile spot is displayed on the LCD 19. Subsequently, the process flow proceeds to step S16. On the other hand, when multiple fragile spots reside (No in step S11), the reinforcement ranges S are set for respective spots. At step 513, it is judged whether or not the reinforcement ranges S overlap with each other, that is, contact or overlapping resides. If the reinforcement ranges S do not overlap with each other (No in step S13), the process flow proceeds to step S12, at which the reinforcement ranges S corresponding to the respective fragile spots are displayed on the LCD 19.

On the other hand, if the reinforcement ranges S overlap with each other (Yes in step S13), a reinforcement range S′ in which the multiple reinforcement ranges S are integrated is calculated at step S14, and the integrated reinforcement range S′ is displayed on the LCD 19 at step S15. In the example of FIG. 6C, the lateral two reinforcement ranges S partially overlap with each other. Accordingly, as illustrated in FIG. 6D, the single reinforcement range S′ in which these ranges are integrated is set.

At next step S16, the shape of the original pattern F contained in the set reinforcement range S or S′ is extracted. At step S17, based on the shape of the extracted original pattern F, data on the shape of the reinforcement pattern R is generated. At step S18, a setting value of whether the folded version is adopted or not is acquired. In this case, for example, if the setting value is “1”, the separate part version is adopted. If the setting value is “2”, the folded version is adopted. The user can preliminarily set the version.

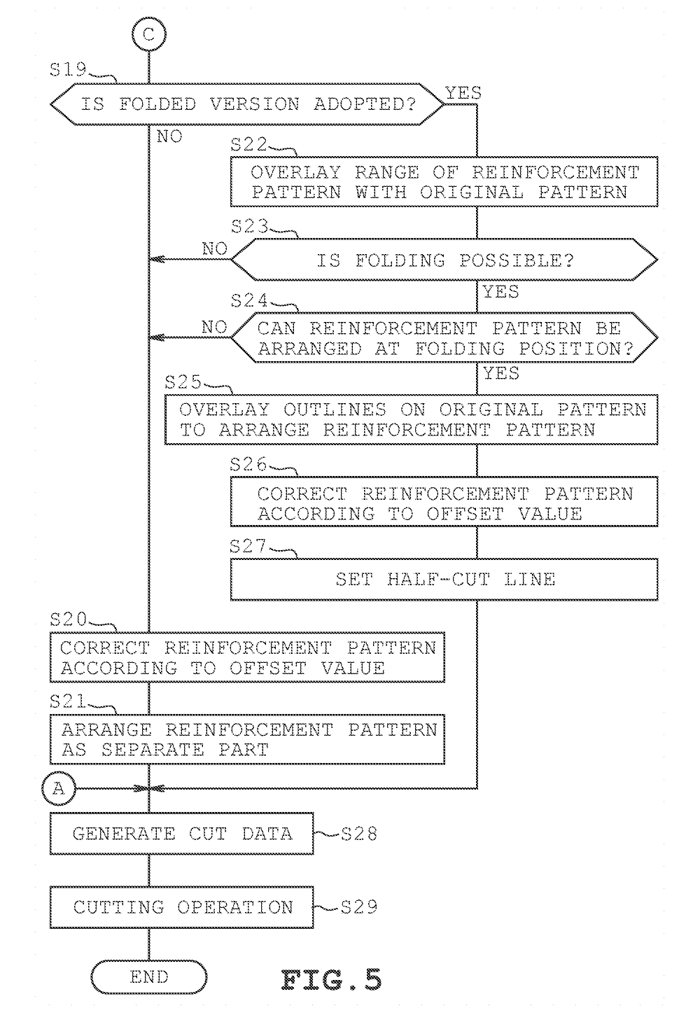

The process flow proceeds to FIG. 5. At step S19, it is judged whether the folded version is set or not. If the folded version is not set (No in step S19), the process flow proceeds to step S20. At step S20, the shape data on the reinforcement pattern R is corrected according to the offset value acquired at step S6, that is, the scaling rate. If the offset value is less than 100%, the reinforcement pattern R is narrowed in the width direction. At step S21, the reinforcement pattern R is arranged as another part different from the original pattern F. FIGS. 7A and 7B illustrate the situation where the original pattern F and the reinforcement pattern R are arranged as separated parts. FIG. 7A illustrates the reinforcement pattern R having an offset value of 100%. FIG. 7B illustrates the reinforcement pattern R in a state of having an offset value of 90%, for example.

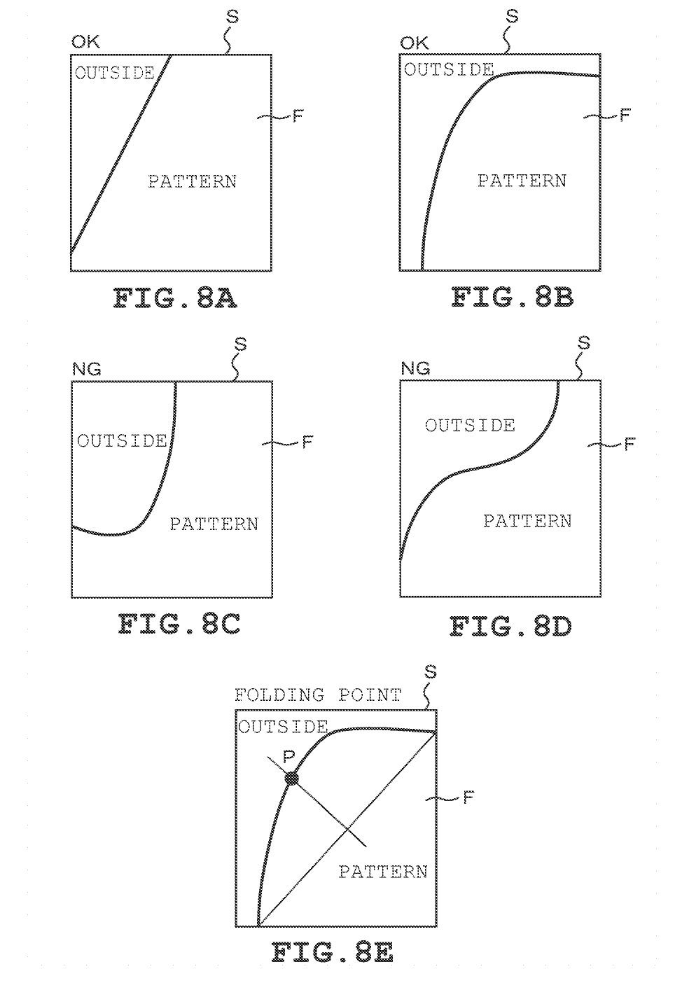

On the other hand, if the folded version is set (Yes in step S19), the partial pattern contained in the reinforcement range S of the original pattern F and the reinforcement pattern R of the data generated based on the reinforcement pattern R at step S17 are overlaid with each other at step S22. At next step S23, it is judged whether the reinforcement pattern R can be folded centered at the outline of the original pattern F or not. The judgment of whether the reinforcement pattern R can be folded or not is described with reference to FIGS. 8A to 8E. In a case where the reinforcement pattern R is arranged in the rectangular region of the reinforcement range S, a case where the outline on which the outline of the original pattern F and the outline of the reinforcement pattern R are in contact or overlap with each other is a straight line as illustrated in FIG. 8A, and a case where a curve has a curve direction that is convex toward the outside as illustrated in FIG. 8B, it is judged that folding is possible.

On the contrary, in a case where the outline is a curve and the curve direction is concave with reference to the outside of the pattern as illustrated in FIG. 8C, and a case where the curve direction of the outline changes between convex and concave states at an intermediate point as illustrated in FIG. 8D, it is judged that folding is impossible. In a case where the outline is a curve and can be folded, a folding point P is set as illustrated in FIG. 8E. That is, a line segment that connects the opposite end points of the outline is drawn, and an orthogonal line passing through the midpoint of the line segment is drawn. A point at which the orthogonal line and the outline intersect with each other is adopted as a folding point P. In this case, the reinforcement pattern R is folded, at the folding point P being adopted as the folding position, in a state of being in contact with the original pattern F.

Returning to FIG. 5, if it is judged that folding is possible (Yes in step S23), it is judged whether or not the reinforcement pattern, that is, the inverted reinforcement pattern R′ in this case can be arranged at the folding position at step S24. That is, in the case where the outline on which the outline of the original pattern F and the outline of the reinforcement pattern R are in contact or overlap with each other is a straight line as illustrated in FIG. 8A, it is judged whether or not the outline of the inverted reinforcement pattern R′ can be arranged in contact or overlapping with the folding position that is this line. In the case of a curve having the curve direction convex toward the outside as illustrated in FIG. 8B, it is judged whether or not the outline of the inverted reinforcement pattern R′ can be arranged in contact or overlapping with the folding point P that is the folding position. More specifically, in the case where the inverted reinforcement pattern R′ is arranged at the folding position with respect to the original pattern F, and the inverted reinforcement pattern R′ or the original pattern F protrudes from the cut target workpiece W, it is judged that the inverted reinforcement pattern R′ cannot be arranged at the folding position. The size acquired at step S1 is used as the size of the cut target workpiece W. In the case where the inverted reinforcement pattern R′ can be arranged at the folding position (Yes in step S24), the inverted reinforcement pattern R′ is arranged so that the outline of the inverted reinforcement pattern R′ can be in contact or overlap with the outline of the original pattern F at step S25. In the example of FIGS. 7A to 7D, the inverted reinforcement pattern R′ is arranged as illustrated in FIG. 7C. Accordingly, the original pattern F and the inverted reinforcement pattern R′ can be cut as an integrated part. The inverted reinforcement pattern R′ in FIG. 7C is acquired by inverting a shape equivalent to the partial shape of the original pattern F in the reinforcement range S, that is, a shape having a scaling rate of 100%.

Subsequently, at step S26, the shape data on the reinforcement pattern R is corrected according to the offset value. In this case, when the reinforcement pattern R is narrowed in the width direction, portions except the folding position are narrowed. Furthermore, at step S27, a half-cut line H, that is, a line with cuts in a manner of a broken line is provided at the folding position, that is, the portion where the outline of the original pattern F and the outline of the inverted reinforcement pattern R′ are overlaid with each other (see FIG. 7C), and the process flow proceeds to step S28. If it is judged that the reinforcement pattern R cannot be folded (No in step S23) or if it is judged that the inverted reinforcement pattern R′ cannot be arranged at the folding position (No in step S24), the process flow proceeds to step S20, and the shape data on the reinforcement pattern R is corrected according to the offset value. At step S21, the reinforcement pattern R is arranged as another part different from the original pattern F, and the process flow proceeds to step S28.

At step S28, the cut data where the original pattern F, and the reinforcement pattern R or the inverted reinforcement pattern R′ are arranged, is generated. At step S29, the cutting operation is performed based on the cut data according to the user's operation. Alternatively, the generated cut data is stored. The cutting operation at step S29 cuts the original pattern F, and the reinforcement pattern R or the inverted reinforcement pattern R′, out of the cut target workpiece W. Accordingly, the user is allowed to acquire automatically the cut object of the original pattern F and the reinforcement part of the reinforcement pattern R configured as a different part. Alternatively, the cut object of the original pattern F and the reinforcement part of the inverted reinforcement pattern R′ having the form joined to this object can be acquired as a single part.

At this time, in a case where the cut target workpiece W is thin, for example, even with situations where the lateral bar portion in the letter pattern F of “A” is prone to being torn, the part for reinforcement is automatically fabricated without the user's manual operation. Consequently, the user overlays and pastes the reinforcement part on the cut object of the original pattern F, thereby allowing effective reinforcement to be achieved and allowing the cut object resistant to being torn to be acquired. Furthermore, in the case of the inverted reinforcement pattern R′, this pattern is not required to be cut off the original pattern F, the part that is the inverted reinforcement pattern R′ is folded to be overlaid with the cut object of the original pattern F, thereby allowing the part to be pasted as it is to achieve reinforcement.

Although detail description has not been made in the flowcharts described above, in the case where the inverted reinforcement pattern R′ is too large, as illustrated in FIG. 7D, the reinforcement pattern can be divided into multiple patterns according to the multiple line segments constituting the outline, the divided reinforcement patterns can be inverted, and the divided inverted reinforcement patterns R″ and the original pattern F can be arranged in a form where the outlines of the divided inverted reinforcement patterns R″ and the outline of the original pattern F are in contact or overlap with each other. Accordingly, in a case where the inverted reinforcement pattern R′ is relatively large while the original pattern F is not required to be cut off, the individual divided inverted reinforcement patterns R″ can be configured to be relatively small, and can be arranged on the single cut target workpiece W.

FIGS. 9A to 11D illustrate the reinforcement pattern R pertaining to the original pattern F different from the letter pattern “A”, that is, the example of the inverted reinforcement pattern R′ in this case. FIG. 9A illustrates the original pattern F made up of the letter pattern “B”. In this case, as illustrated in FIG. 9B, the line L at an end of the lateral bar part at the center, for example, is detected as the fragile spot. As illustrated in 9C, in a case where the shape of the reinforcement range S having the minimum size is set at step S5, the laterally elongated reinforcement range S is set. In this case, as illustrated in FIG. 9D, the inverted reinforcement pattern R′ is generated.

As illustrated in FIG. 10, even in the case of the original pattern F made up of the letter pattern “B”, as illustrated in FIG. 10C, when the shape of the rectangular reinforcement range S is set at step S5, the inverted reinforcement pattern R′ as illustrated in FIG. 10D is generated. FIGS. 11A to 11D exemplify the original pattern F made up of a letter pattern “O” (FIG. 11A). In this case, as illustrated in FIG. 11B, the lines L at the vertically opposite ends are detected as the fragile spots. As illustrated in FIG. 11C, the reinforcement range S is set, and two inverted reinforcement patterns R′ are generated as illustrated in FIG. 11D.

This embodiment can thus acquire the following operation and advantageous effects. That is, for generating the cut data, upon specification of the original pattern F that is the cut target, the control circuit 29 generates a reinforcement pattern R that is accommodated in at least the partial shape of the original pattern F and is for reinforcement by being overlaid on the original pattern F based on the shape of the original pattern F, and generates the cut data for cutting the original pattern F and the reinforcement pattern R out of the cut target workpiece W. Consequently, this embodiment can cut the reinforcement pattern R out of the cut target workpiece W according to the cut data to acquire the reinforcement part. As a result, an excellent effect can be achieved that is capable of generating the cut data for cutting the original pattern F having the predetermined shape out of the cut target workpiece W, the cut data being for allowing the cutting apparatus 11 to cut the reinforcement part for preventing the cut object from being torn off.

According to this embodiment, for generating the reinforcement pattern R, the control circuit 29 is configured to set the predetermined range for reinforcement (reinforcement range) S at a part of the original pattern F, and to generate the reinforcement pattern R corresponding to the shape of the partial pattern contained in the reinforcement range S. Accordingly, the reinforcement pattern R corresponding to the shape of a partial pattern contained in the reinforcement range S can be automatically generated. In this case, the configuration is adopted that automatically changes the size of the reinforcement range S according to the width dimension of the fragile spot in the original pattern F. Consequently, the reinforcement pattern R having the size according to the dimensions of the fragile spot can be acquired, the size of the reinforcement pattern R can be prevented from being uselessly increased and excessively reduced, and a further excellent reinforcement effect can be exerted. In the case where the adjoining reinforcement ranges S are in contact or overlap with each other, the configuration is adopted that integrates the reinforcement ranges S to generate the reinforcement pattern R, thereby allowing the number of reinforcement patterns R to be reduced.

In this case, particularly, according to this embodiment, the fragile spot is automatically detected, and the reinforcement range S is set so as to contain the fragile spot. Consequently, the spot prone to being cut off can be reinforced, and the user's efforts are advantageously reduced. The narrow width portion or the bent portion in the original pattern, or the bent corner portion in the outline of the original pattern is automatically detected as the fragile spot. Consequently, the spot prone to be cut off can be securely detected.

Furthermore, this embodiment has the configuration where the reinforcement pattern R is generated to have the shape equivalent to the shape of the part of the original pattern F, or generated to have the form having the reduced width direction dimension. The reinforcement pattern R thus has the shape equivalent to the part of the original pattern F. Consequently, the reinforcement operation of overlaying and pasting in a manner of allowing the user to recognize the portion easily can be readily performed. The reinforcement pattern R is required not to protrude from the original pattern F in view of aesthetic and the like. Adoption of the shape having the reduced width direction dimension of the reinforcement pattern R prevents the pattern from protruding even with rough pasting to a certain extent. Accordingly, the failure during pasting can be allowed to be reduced.

In particular, according to this embodiment, for arranging the original pattern F and the reinforcement pattern R so as to cut these patterns out of the single cut target workpiece W, the control circuit 29 can invert the reinforcement pattern R, and arrange the inverted reinforcement pattern R′ and the original pattern F in the form where the outline of the inverted reinforcement pattern R′ and the outline of the original pattern F are in contact or overlap with each other. Accordingly, the original pattern F and the inverted reinforcement pattern R′ can be integrally cut in a state of being joint to each other. The inverted reinforcement pattern R′ can be folded without being cut off to thereby be overlaid with the original pattern F. The reinforcement can be achieved with the pattern being pasted as it is without being cut off, thereby facilitating the reinforcement operation.

According to this embodiment, the case where the reinforcement pattern R is generated based on the shape of the multiple line segments constituting the outline of the original pattern F, the reinforcement pattern R can be divided into multiple patterns according to the multiple line segments, the divided reinforcement patterns R can be inverted, and the divided inverted reinforcement patterns R″ and the original pattern F can be arranged in a form where the outlines of the divided inverted reinforcement patterns R″ and the outline of the original pattern F are in contact or overlap with each other. Accordingly, arrangement of the multiple divided inverted reinforcement patterns R″ can negate the need of cutting the divided inverted reinforcement patterns R″ out of the original pattern F, and prevent the entire size from being increased in comparison with the case of the single inverted reinforcement pattern R′.

Furthermore, particularly, according to this embodiment, it is judged whether the original pattern F and the inverted reinforcement pattern R′ can be arranged in the size of the cut target workpiece W, and the reinforcement pattern R and the original pattern F are arranged independently from each other in the case where the arrangement is impossible. Consequently, it is confirmed that the inverted reinforcement pattern R′ or the separated reinforcement pattern R can be arranged according to the size of the margin of the cut target workpiece W, and then the pattern R′ or the separated reinforcement pattern R can be automatically arranged.

### (2) Second Embodiment and Other Embodiments

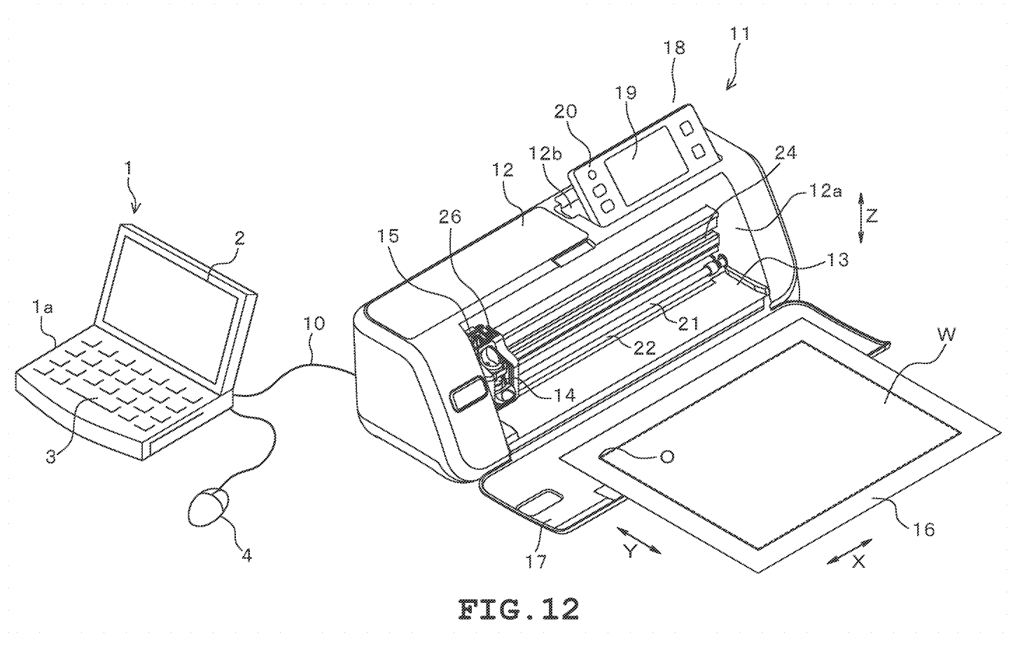

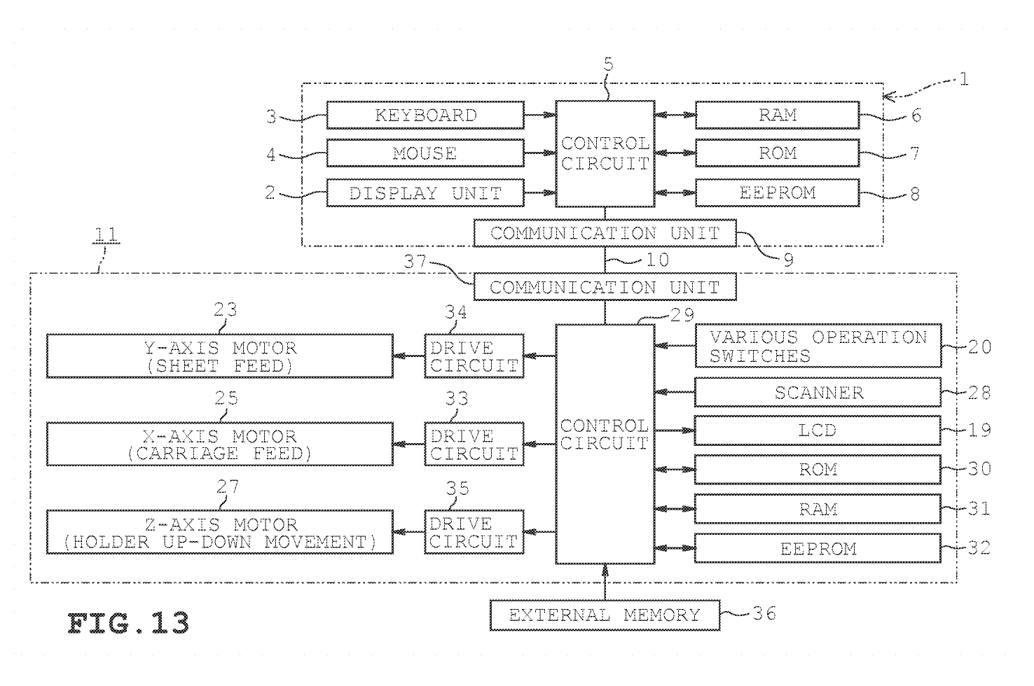

FIGS. 12 and 13 illustrate a second embodiment of the present disclosure. FIG. 12 illustrates an appearance configuration of a cut data generating apparatus 1 and a cutting apparatus 11 according to this embodiment. FIG. 13 schematically illustrates electrical configurations of these apparatuses. The cut data generating apparatus 1 according to this embodiment includes a personal computer, for example, and is connected to the cutting apparatus 11 through a communication cable 10. The cutting apparatus 11 is an apparatus that cuts a cut target workpiece W, such as paper or a sheet, according to cut data.

The cut data generating apparatus 1 includes a personal computer that executes a cut data generating program. As illustrated in FIG. 12, the cut data generating apparatus 1 includes a computer main body 1a, and further includes a display unit 2, a keyboard 3, and a mouse 4 in this body la. As illustrated in FIG. 13, the computer main body 1a includes a control circuit 5 configured by mainly including a CPU, and a RAM 6, a ROM 7, an EEPROM 8, a communication unit 9 and the like that are connected to the control circuit 5.

The display unit 2 displays necessary information, such as a message for the user. The keyboard 3 and the mouse 4 are operated by the user. Operation signals thereof are input into the control circuit 5. The RAM 6 temporarily stores the necessary information according to a program executed by the control circuit 5. The ROM 7 stores a cut data generating program and the like. The EEPROM 8 stores data on various patterns that are generation targets of cut data (outline data, etc.), generated cut data and the like. A scanner, not illustrated, may be connected to the cut data generating apparatus 1, thereby allowing data on the pattern to be input.

The communication unit 9 is configured to communicate data and the like with external apparatuses. In this embodiment, cut data generated by the cut data generating apparatus 1 is transmitted by the communication unit 9 through the communication cable 10 to the communication unit 37 of the cutting apparatus 11. The communication unit 9 of the cut data generating apparatus 1 and the communication unit 37 of the cutting apparatus 11 may be connected to each other via wireless communication. The cut data may be exchanged between the cut data generating apparatus 1 and the cutting apparatus 11 via a detachable external device, such as a USB memory, or via a network, such as the Internet, although not illustrated.

In this embodiment, the cut data generating apparatus 1 (control circuit 5) executes the cut data generating program to execute various processes as the cut data generating apparatus that generates the cut data. For generating the cut data, when the user operates the keyboard 3 or mouse 4 to specify the original pattern F, the control circuit 5 generates the reinforcement pattern R that is accommodated in the partial shape of the original pattern F and is for reinforcement by being overlaid on the original pattern F, based on the shape of the specified original pattern F. In a case where the reinforcement pattern R is generated, the control circuit 29 generates cut data for cutting both the original pattern F and the reinforcement pattern R out of the cut target workpiece W. Consequently, the keyboard 3 or the mouse 4 functions as a specification unit, and the control circuit 5 functions as a reinforcement pattern generating unit and a cut data generating unit.

For generating the reinforcement pattern R for the original pattern F, the control circuit 5 automatically detects the fragile spot in the original pattern F, sets the reinforcement range S and generates the reinforcement pattern R corresponding to the shape of the partial pattern of the original pattern F contained in the reinforcement range S. Furthermore, the control circuit 5 also arranges the reinforcement pattern R and the original pattern F so as to cut the patterns R and F out of one cut target workpiece W. In this case, the size of the cut target workpiece W is acquired, the reinforcement pattern R separated from the original pattern F according to the size and the like, that is, the size of the remaining margin after arrangement of the original pattern F, generates the inverted reinforcement pattern R′ acquired by inverting the reinforcement pattern R, and generates the multiple divided inverted reinforcement patterns R″. Consequently, the control circuit 5 also functions as the range setting unit, the arrangement unit, and the size information acquisition unit.

Also according to the second embodiment, as with the first embodiment, the generated cut data allows the reinforcement pattern R to be cut out of the cut target workpiece W to acquire the reinforcement part. As a result, the excellent effects can be acquired that includes the capability of generating the cut data that is for cutting the pattern F having the predetermined shape out of the cut target workpiece W and allows the cutting apparatus 11 to cut the reinforcement part for preventing the cut object from being torn.

In the embodiment described above, the reinforcement range S is automatically set according to the threshold of the width dimension of the fragile spot. Alternatively, a configuration may be adopted that allows the user to specify the position of the reinforcement range S through the manual operation and to specify the size. The bent spot of the original pattern F may be detected, and the reinforcement range S may be set centered at the spot. A configuration may be adopted that allows the user to select whether the reinforcement pattern R is generated or not. The numeric values of the threshold, the size of the reinforcement range and the like are only examples, and can be appropriately changed.

Furthermore, in each embodiment described above, the cut data generating apparatus is made up of the cutting apparatus, or a general personal computer. Alternatively, the cut data generating apparatus may be configured as an apparatus dedicated to cut data generation. A configuration may be adopted where the cut data generating apparatus is connected to a scanner that reads data on a graphical item from an original diagram. Alternatively, the present disclosure is not limited to each embodiment described above. The specific configuration of the cutting apparatus can be variously changed. Appropriate changes may be applied in a range without departing from the spirit of the present disclosure.

In the embodiments described above, a single CPU may perform all of the processes. Nevertheless, the disclosure may not be limited to the specific embodiment thereof, and a plurality of CPUs, a special application specific integrated circuit (“ASIC”), or a combination of a CPU and an ASIC may be used to perform the processes.

The foregoing description and drawings are merely illustrative of the principles of the disclosure and are not to be construed in a limited sense. Various changes and modifications will become apparent to those of ordinary skill in the art. All such changes and modifications are seen to fall within the scope of the disclosure as defined by the appended claims.

What is claimed is:

1. A cut data generating apparatus for generating cut data for allowing a cutting apparatus including a cutting mechanism to cut a pattern out of a cut target workpiece, the cut data generating apparatus comprising:
a controller,
the controller being configured to control the cut data generating apparatus to:
specify an original pattern that is a target of cutting;
generate a reinforcement pattern that is accommodated in an inside of a shape of at least a part of the original pattern based on a shape of the specified original pattern, and is overlaid on the original pattern to achieve reinforcement; and
generate cut data for cutting the original pattern and the reinforcement pattern out of the cut target workpiece.

2. The cut data generating apparatus according to claim 1,
the controller being configured to further control the cut data generating apparatus to:
generate the reinforcement pattern having a shape equivalent to the shape of the part of the original pattern.

3. The cut data generating apparatus according to claim 1,
the controller being configured to further control the cut data generating apparatus to:
generate the reinforcement pattern having a form with a reduced width direction dimension with respect to the shape of the part of the original pattern.

4. The cut data generating apparatus according to claim 1,
the controller being configured to further control the cut data generating apparatus to:
set a predetermined range for reinforcement to the original pattern; and
generate the reinforcement pattern corresponding to a shape of a partial pattern contained in the predetermined range set in the original pattern.

5. The cut data generating apparatus according to claim 4,
the controller being configured to further control the cut data generating apparatus to:
detect a narrow width portion or a bent portion of the original pattern as a fragile spot, and
set the predetermined range so as to contain the fragile spot.

6. The cut data generating apparatus according to claim 5,
the controller being configured to further control the cut data generating apparatus to:
detect a corner portion that is of an outline of the original pattern and has a bent shape, as the fragile spot.

7. The cut data generating apparatus according to claim 4,
the controller being configured to further control the cut data generating apparatus to:
change a size of the predetermined range according to a width dimension of the fragile spot.

8. The cut data generating apparatus according to claim 4,
the controller being configured to further control the cut data generating apparatus to:
integrate predetermined ranges set at a plurality of spots, and generate the reinforcement pattern, in a case where adjoining predetermined ranges are in contact or overlap with each other.

9. The cut data generating apparatus according to claim 1,
the controller being configured to further control the cut data generating apparatus to:
invert the reinforcement pattern, and
arrange the inverted reinforcement pattern and the original pattern in a form where an outline of the inverted reinforcement pattern and an outline of the original pattern overlap with each other.

10. The cut data generating apparatus according to claim 9,
the controller being configured to further control the cut data generating apparatus to:
in a case where the reinforcement pattern is generated based on shapes of a plurality of line segments constituting the outline of the original pattern, divide the reinforcement pattern into a plurality of patterns according to the plurality of line segments, invert each of the divided reinforcement patterns, and arrange the inverted reinforcement patterns and the original pattern in a form where outlines of the plurality of divided inverted reinforcement patterns and outlines of the original pattern overlap with each other.

11. The cut data generating apparatus according to claim 9,
the controller being configured to further control the cut data generating apparatus to:
acquire a size of the cut target workpiece;
judge whether or not the original pattern and the inverted reinforcement pattern can be arranged in the size of the cut target workpiece; and
arrange the reinforcement pattern separately from the original pattern when arrangement is impossible.

12. A non-transitory recording medium storing a cut data generating program, the cut data generating program including instructions for a computer which has a controller,
the instructions cause, when executed by the controller, the computer to:
specify an original pattern that is a target of cutting;
generate a reinforcement pattern that is accommodated in an inside of a shape of at least a part of the original pattern based on a shape of the specified original pattern, and is overlaid on the original pattern to achieve reinforcement; and
generate cut data for cutting the original pattern and the reinforcement pattern out of the cut target workpiece.

13. The non-transitory recording medium according to claim 12,
the instructions further cause, when executed by the controller, the computer to:
generate the reinforcement pattern having a shape equivalent to the shape of the part of the original pattern.

14. The non-transitory recording medium according to claim 12,
the instructions further cause, when executed by the controller, the computer to:
generate the reinforcement pattern having a form with a reduced width direction dimension with respect to the shape of the part of the original pattern.

15. The non-transitory recording medium according to claim 12,
the instructions further cause, when executed by the controller, the computer to:
set a predetermined range for reinforcement to the original pattern; and
generate the reinforcement pattern corresponding to a shape of a partial pattern contained in the predetermined range set in the original pattern.

16. The non-transitory recording medium according to claim 15,
the instructions further cause, when executed by the controller, the computer to:
detect a narrow width portion or a bent portion of the original pattern as a fragile spot, and
set the predetermined range so as to contain the fragile spot.

17. The non-transitory recording medium according to claim 16,
the instructions further cause, when executed by the controller, the computer to:
detect a corner portion that is of an outline of the original pattern and has a bent shape, as the fragile spot.

18. The non-transitory recording medium according to claim 15,
the instructions further cause, when executed by the controller, the computer to:
change a size of the predetermined range according to a width dimension of the fragile spot.

19. The non-transitory recording medium according to claim 12,
the instructions further cause, when executed by the controller, the computer to:
invert the reinforcement pattern, and
arrange the inverted reinforcement pattern and the original pattern in a form where an outline of the inverted reinforcement pattern and an outline of the original pattern overlap with each other.

20. The non-transitory recording medium according to claim 19,
the instructions further cause, when executed by the controller, the computer to:
acquire a size of the cut target workpiece;
judge whether or not the original pattern and the inverted reinforcement pattern can be arranged in the size of the cut target workpiece; and
arrange the reinforcement pattern separately from the original pattern when arrangement is impossible.
